(19) United States
(12) Patent Application Publication
(10) Pub. No.: US 2021/0132402 A1
(43) Pub. Date: May 6, 2021

(54) MULTIPLE WAY PRISM FOR B4-STANDARD

(71) Applicant: SUPPONOR HOLDING LIMITED, London, England (GB)

(72) Inventors: Mario SONDERMANN, Kreischa (DE); Torsten ANTRACK, Jena (DE)

(73) Assignee: SUPPONOR HOLDING LIMITED, London, England (GB)

(21) Appl. No.: 16/635,816

(22) PCT Filed: Jul. 31, 2018
(86) PCT No.: PCT/EP2018/070671

§ 371 Date: Jan. 31, 2020

(30) Foreign Application Priority Data
Jul. 31, 2017 (DE) 10 2017 117 319.6

(51) Int. Cl. G02B 27/12; G02B 5/04; G03B 17/17; G02B 27/10

(52) U.S. Cl. CPC G02B 27/126; G02B 27/106; G03B 17/17; G02B 5/045

(57) ABSTRACT

Provided is an optical arrangement comprising a stacked structure having at least three prisms. The optical arrangement also comprises a primary optical path and a secondary optical path for each of the prisms. The secondary optical path runs through the corresponding prism, is connected with the primary optical path by means of partial reflection of light, and is subject to total reflection at a further surface of the corresponding prism.

### TECHNICAL FIELD

Various embodiments of the invention relate to an optical arrangement which comprises a stack structure having at least three prisms. Further embodiments of the invention relate to a corresponding lens connection for a camera.

### BACKGROUND

Optical arrangements having multiple prisms (multi-path prisms) are used to split or combine light into multiple channels. The light can be split and/or combined, for example, with regard to the spectral range.

FIG. 1 illustrates an optical arrangement 100 that is known from the prior art. The optical arrangement 100 comprises four prisms 121, 122, 123, 124 in a stack structure, each of which splits light 110 into a corresponding channel 111, 112, 113, 114. A wedge 131 is arranged between the prisms 122 and 123 and inside the stack structure. For this reason, the channels 111, 112 are rotated relative to the channels 113, 114. An optical disc 132 which defines another channel 115 is also provided.

A further optical arrangement is known from U.S. Pat. No. 6,181,414 B1: FIG. 2. In comparison to the optical arrangement according to FIG. 1, the channels are all in one plane and the wedge 131 is omitted.

These optical arrangements can have certain disadvantages. For example, the corresponding stack structure can be comparatively complex. For example, the constructed space required to implement a stack structure that includes the prisms used can be comparatively large. Accordingly, the resulting optical arrangement may require a comparatively large constructed space. In particular, the constructed space required per channel can be comparatively large.

### SUMMARY

For this reason, there is a need for improved optical arrangements which have multiple prisms for splitting or combining light. In particular, there is a need for optical arrangements which require comparatively little constructed space.

This object is achieved by the features of the independent claims. The features of the dependent claims define embodiments.

An optical arrangement comprises a stack structure. The stack structure comprises at least one glass. The stack structure also includes at least three prisms. Each of the at least three prisms comprises a first surface and an opposite second surface. The optical arrangement further comprises a primary optical path. The primary optical path runs through the stack structure. The optical arrangement also comprises, for each of the prisms of the stack structure, a corresponding secondary optical path which runs through the corresponding prism and which is connected to the primary optical path by the partial reflection of light on the second surface of the corresponding prism. Each of the secondary optical paths can also be subject to total reflection on the first surface of the corresponding prism. The glass path through the stack structure along the primary path and along the various secondary paths is in the range from 43.0 mm to 46.0 mm. It would optionally be possible for the glass path through the stack structure along the primary path and along the various secondary paths to be in the range of from 43.4 mm to 45.4 mm, further optionally in the range of from 44.0 mm to 44.8 mm, and further optionally in the range of from 44.3 mm to 44.6 mm.

With a glass path which is sized in this way, the optical arrangement can be integrated into a lens connection. In particular, it may be possible for the optical arrangement to be made particularly small, and at the same time for a lateral expansion of the light field—that is to say, the image field diameter—along the primary optical path and/or the secondary optical paths to be comparatively large. In this way, for example in connection with imaging using a camera, high-quality images can be generated without the need for particularly large or heavy lens connections.

In particular, the sizing of the glass path mentioned above makes it possible to provide a lens connection, by means of the optical arrangement, which is designed in accordance with the Broadcasting Technology Association (BTA) S-1005B Standard—that is, corresponding to a B4 connection.

The lens connection could be designed as an intermediate ring. This means that the lens connection, which is designed as an intermediate ring, can be positioned, for example, between a lens of the camera and a main body of the camera. For example, a detector could be arranged in the main body of the camera. The detector of the main body could then receive light from the lens connection, which has passed through the stack structure along the primary optical path—for example, in a straight line and without deflection. The main body detector could be assigned to a channel of the stack structure.

The realization of a lens connection corresponding to the BTS S-1005B standard can also be facilitated by implementing one or more of the following features:
The refractive index of the at least one glass lies, along the primary path and along the various secondary paths, in the range of from 1.59-1.65, optionally in the range of from 1.61-1.63; and/or
The Abbe number of the at least one glass lies, along the primary path and along the various secondary paths, in the range of from 46.8 to 52.8, optionally in the range of from 48.8 to 50.8. The Abbe number characterizes the change in the refractive index as a function of the wavelength of the light—that is, the optical dispersion.

In particular, it may be possible for the refractive index and the Abbe number to be in the ranges mentioned.

In other words, it may be possible that the refractive index and/or the Abbe number have a comparatively small variation as a function of the location within the prisms—that is, that the light which passes through the stack structure has no or only a comparatively small variation in the refractive index and/or the Abbe number within the at least one glass. Such a small variation in the refractive index and/or the Abbe number can be facilitated by the stack structure and/or the at least three prisms being made from a single glass. This means that in order to implement an optical arrangement in accordance with the BTS S-1005B standard, it may be desirable to avoid using multiple different glasses.

The stack structure can be obtained, for example, by stacking the different prisms on top of one another. Adjacent prisms can adjoin each other—that is, they can be arranged next to each other without further optical glass components being inserted between. By way of example, an air gap and/or a filter can be arranged between adjacent prisms of the stack structure. Air within the air gap and glass of the different prisms can define different optical media in this way—that is, media with different refractive indices. Further optical components made of glass which influence the path of light through the stack structure cannot be provided between adjacent prisms. This means that it is possible that the transitions between different optical media along the primary optical path within the stack structure are formed only by the surfaces of the prisms of the stack structure. Other structures that would produce transitions between different optical media cannot be present. A particularly small constructed space for the optical arrangement can be achieved by using such a stack structure. In addition, the optical arrangement can be constructed in a comparatively simple manner with little complexity.

It may also be possible for the stack structure to be made from exactly one glass. In other words, this can mean that the different prisms of the stack structure can all be made of the same glass, by way of example. Optionally available further optical elements, for example optical discs etc., can also be made from this glass.

An exemplary glass that could be used is the glass “N-SSK8” from Schott AG, Mainz, Germany.

Using a single type of glass can achieve particularly high integration and a structure of low complexity.

A first prism of the stack structure can form the outer prism. By way of example, the outer prism can bound the stack structure. A further outer prism can be arranged on the other side of the stack structure. Further prisms can be arranged between the outer prism and the further outer prism.

For example, a prism can define a geometric body that has a polygon as the base and whose lateral edges are parallel and of equal length, for example. By way of example, the prism can define a geometric body that has a triangle as the base. For example, the first surface and the second surface can be arranged to be non-parallel to each other—that is, to form a prism angle together. For example, the prism can have a glass body that defines the first surface and the second surface. The glass body can also define further surfaces—for example, an exit surface. By way of example, the exit surface can be arranged perpendicular to the respective secondary optical path, such that no deflection—or no significant deflection—of the light along the secondary path occurs at the exit surface.

For example, the prisms of the stack structure can be Bauernfeind prisms. In this way, a specific geometric configuration can be achieved. The Bauernfeind prism can achieve a deflection of the secondary optical path from the primary optical path in a range of from 45° to 60°. The Bauernfeind prism selects light through partial reflection and total reflection.

With a suitable selection of the prism angles, partial reflection and/or total reflection can occur within the prism. The partial reflection and/or total reflection can also be made possible by the air gaps between adjacent surfaces of adjacent prisms and/or filters. In various examples, it is possible that the prisms of the stack structure have at least partially different prism angles. However, it is also possible for the prism angle to be the same for all prisms in the stack structure. In such a case, a particularly small design of the optical arrangement can be ensured, since the various prisms can be stacked in a space-efficient manner.

The primary optical path can denote, for example, that path of light through the stack structure and/or the optical arrangement which corresponds to a central beam of parallel arriving light. The primary optical path can denote, for example, the path of light through the stack structure which does not undergo any reflection on the different first and second surfaces of the prisms. Correspondingly, the secondary optical paths can each designate the paths which light, undergoing partial reflection on the given second surfaces of the prisms of the stack structure, selects.

In one example, the prisms of the stack structure are all shaped identically. This can mean that the first and second surfaces of the prisms have the same dimensions and the different prisms also have the same prism angles. In this way, it can be possible to ensure a particularly efficient production of the optical arrangement. In particular, it is possible to use the same manufacturing processes for all prisms in the stack structure.

In some examples, the optical arrangement may also include a wedge with a first surface and a second surface. The wedge can be arranged in the primary optical path adjacent to the first surface of an outer prism of the stack structure. The second surface of the wedge can be arranged parallel to the first surface of the outer prism. All adjacent surfaces of prisms arranged side by side in the stack structure can be parallel to each other.

For example, it is possible that a wedge angle of the wedge lies in the range of from 40% to 60% of the prism angle of the prisms of the stack structure. This means that it is possible that the wedge angle of the wedge is approximately half as large as the prism angle of the prisms of the stack structure. With such a wedge angle, it can be particularly easy to ensure that identically shaped prisms or prisms with the same are used.

It is possible that the primary optical path and the secondary optical paths within the stack structure are all in one plane. This means that a rotation of the channels can be avoided. In this way it can be possible to ensure a particularly simple arrangement of detectors and/or light sources within the different channels. In particular, the constructed space of the optical arrangement can be reduced.

For example, it is possible that each prism of the stack structure further comprises an exit surface. The exit surface can be arranged perpendicular to the corresponding secondary optical path. For at least one prism of the stack structure, the optical arrangement can furthermore comprise an optical disc arranged in the given secondary optical path adjacent to the exit surface of the corresponding prism. The optical disc can have a first surface and a second surface which are arranged parallel to each other, and furthermore parallel to the corresponding exit surface. For example, different prisms can have optical discs of different thicknesses. By way of example, different thicknesses of the optical discs can ensure that light that is assigned to different channels of the optical arrangement passes through the same glass path in each case. At the same time, the provision of the optical discs ensures that the different prisms are as identical in construction as possible. The optical discs can also be made of the same glass as the prisms.

For example, for at least one prism of the stack structure, the optical arrangement can further comprise a further optical wedge, having a first surface and a second surface, arranged in the corresponding secondary optical path adjacent to the exit surface of the corresponding prism. The first and second surfaces of the further optical wedge can together form a wedge angle. The first surface of the further optical wedge can be arranged parallel to the corresponding exit surface. For example, a filter can be arranged on the second surface of the optical wedge. Partial reflection can take place on the second surface of the further optical wedge. Providing the further optical wedge can achieve splitting the corresponding secondary optical path; this can make it possible to provide more than one channel per prism. In this way, the constructed space required per channel can be reduced.

In particular, it may be possible for the exit surfaces of prisms of the stack structure which are next to each other to be parallel to each other. By way of example, the parallel exit surfaces can be arranged offset to each other—for example, parallel to the respective secondary optical paths. In this way, a particularly efficient arrangement of detectors and/or light sources in the different channels can be achieved. For example, it may be possible to couple the focus of detectors and/or light sources into the different channels.

It is possible that appropriate filters are provided for the selection of light with certain properties. For example, it is possible for the optical arrangement to comprise a filter for each prism of the stack structure. For example, the filter can be arranged parallel to the corresponding second surface of the corresponding prism. The filter can perform a partial reflection in terms of the spectral range and/or the polarization and/or the transmission of light.

For example, the filter could be a high pass filter or a low pass filter that selectively allows blue light or red light to pass. The filter could also be a bandpass filter, which allows light with certain colours of the spectrum to pass selectively. The filter could also be spectrally insensitive—that is, can affect all spectral ranges equally. In this case, the filter could, for example, specify a certain transmission value. The filter could also be a polarization filter, which reflects a certain polarization of the light.

It is possible that the optical arrangement comprises at least one channel for each prism of the stack structure. For example, each channel can have a light source and/or a detector. The light source and/or the detector can be arranged in the corresponding secondary optical path outside the stack structure.

A channel can thus designate those elements that are required for selecting and/or emitting light along a secondary optical path. The channel can thus allow external access to the properties of the light of the respective secondary optical path.

By way of example, the light source can be a light emitting diode (LED) or a laser. For example, the light source can emit monochromatic light or light in a certain spectral range. For example, the light source can emit white light. A further example of a light source is a display with multiple pixels, for example. A further example of a light source is a digital micromirror device (DMD), for example. Microoptoelectromechanical systems (MOEMS) can also be used as the light source.

In principle, it is possible that the optical arrangement comprises more channels than prisms. In particular, it may be possible to separate more than one channel per prism. This can be done, for example, by means of the further optical wedge mentioned above. Alternatively or additionally, at least one channel can also be assigned to the primary optical path. For example, the stack structure could comprise four prisms; at the same time, the optical arrangement can comprise at least five channels, for example seven channels.

For example, the channels can comprise detectors with one sensor plane each. The sensor planes of the detectors of closest-adjacent prisms of the stack structure can be parallel to each other. This enables a particularly high level of integration to be achieved, which in particular enables a design corresponding to the BTS S-1005B standard.

For example, each sensor plane can comprise a pixel matrix with several pixels. For example, the sensor plane can be formed by a CMOS sensor or a CCD sensor.

Parallel sensor planes can ensure a particularly simple arrangement of the different detectors relative to each other. For example, the different detectors can be affixed to a single substrate. It is also possible for the optical arrangement to comprise a positioning mechanism. The positioning mechanism can be configured, for example, to couple the positioning of the sensor planes of the detectors from prisms that are next to each other—that is, parallel sensor planes. In this way, for example, particularly simple focusing can take place. In particular, the positioning mechanism can, for example, adjust the mutually parallel sensor planes by the same amount along the different secondary optical paths. For example, the positioning mechanism that positions two parallel sensor planes can have only one single motor that is used for the positioning of both sensor planes.

It is also possible to perform a correlated positioning of the sensor planes parallel to the sensor plane and perpendicular to the secondary optical paths. For example, the sensor planes of two of the detectors can be offset perpendicular to the corresponding secondary optical path by a distance that is smaller than the dimension of a pixel of the sensor planes. A sub-pixel resolution can be achieved in this way if the information from the different detectors is combined.

An optical arrangement comprises a stack structure. The stack structure comprises at least one glass. The stack structure also includes at least three prisms. Each of the at least three prisms comprises a first surface and an opposite second surface. The optical arrangement further comprises a primary optical path. The primary optical path runs through the stack structure. The optical arrangement also comprises, for each of the prisms of the stack structure, a corresponding secondary optical path which runs through the corresponding prism and which is connected to the primary optical path by the partial reflection of light on the second surface of the corresponding prism. Each of the secondary optical paths can also be subject to total reflection on the first surface of the corresponding prism. The refractive index of the at least one glass along the primary path and along the secondary paths is in the range of from 1.59 to 1.65, optionally in the range of from 1.61 to 1.63.

An optical arrangement comprises a stack structure. The stack structure comprises at least one glass. The stack structure also includes at least three prisms. Each of the at least three prisms comprises a first surface and an opposite second surface. The optical arrangement further comprises a primary optical path. The primary optical path runs through the stack structure. The optical arrangement also comprises, for each of the prisms of the stack structure, a corresponding secondary optical path which runs through the corresponding prism and which is connected to the primary optical path by the partial reflection of light on the second surface of the corresponding prism. Each of the secondary optical paths can also be subject to total reflection on the first surface of the corresponding prism. The Abbe number of the at least one glass, along the primary path and along the various secondary paths, lies in the range of from 46.8 to 52.8, optionally in the range of from 48.8 to 50.8.

The features set out above, and features which are described below, can be used not only in the corresponding explicitly stated combinations, but also in further combinations or in isolation, without departing from the scope of protection of the present invention.

### BRIEF DESCRIPTION OF THE FIGURES

FIG. 1 illustrates a multi-path prism, which is known from the prior art.

FIG. 2 illustrates a multi-path prism according to various embodiments, the multi-path prism comprising four prisms and five channels.

FIG. 3 illustrates a multi-path prism according to various embodiments, the multi-path prism comprising three prisms and five channels, wherein the multi-path prism further comprises a wedge arranged in front of an outer prism.

FIG. 4 schematically illustrates the beam path of light through the multi-path prism of FIG. 3.

FIG. 5 illustrates a multi-path prism according to various embodiments, the multi-path prism comprising four prisms and seven channels, wherein the multi-path prism further comprises a wedge arranged in front of an outer prism.

FIG. 6 illustrates a camera with two multi-path prisms according to the prior art.

FIG. 7 illustrates a camera according to various embodiments, wherein a lens connection of the camera comprises a multi-path prism according to various embodiments.

### DETAILED DESCRIPTION OF EMBODIMENTS

The properties, features and advantages of this invention described above, and the manner in which they are achieved, can be more clearly understood in connection with the following description of the exemplary embodiments, which are explained in more detail in connection with the drawings.

The present invention is explained in more detail below on the basis of preferred embodiments with reference to the drawings. In the figures, the same reference numbers designate the same or similar elements. The figures are schematic representations of various embodiments of the invention. Elements shown in the figures are not necessarily drawn to scale. Rather, the various elements shown in the figures are reproduced in such a way that their function and general purpose can be understood by a person skilled in the art. Connections and couplings between functional units and elements shown in the figures can also be implemented as an indirect connection or coupling.

Techniques for combining or splitting light are described below. According to various examples, light can be split/combined in terms of the spectral range, the polarization and/or the intensity/transmission.

In various examples, the techniques described herein are based on the use of a multi-path prism. In various examples, the multi-path prisms described herein include four channels, five channels, six channels, seven channels, or more channels. The multi-path prisms described herein comprise a stack structure which comprises multiple prisms. For example, the stack structure can include three or more prisms.

Such a multi-path prism can be arranged between an imaging optical system, for example a camera lens, and a plurality of detectors or light sources which are associated with different channels of the multi-path prism. In other words, this means that the multi-path prism can be arranged within the focal length of the imaging optics.

Such optical arrangements can generally be used in a wide variety of applications. An example of an application is an illumination/projection device. For example, the combination of information from four, five or more different channels with assigned light sources—for example, light sources with different spectra or displays, MOEMS or DMDs—can be implemented. For example, a sub-pixel overlay can be generated by a corresponding offset between the light sources of the different channels. Further applications include, for example, coupling-in laser pointers, markers, autofocus beam paths, calibration beam paths, or measurement beam paths.

A further exemplary application relates to a detection device, such as a camera. Image information is split into the various channels. For example, the splitting can take place with respect to different spectral ranges. In such an example too, a sub-pixel overlay by a corresponding offset between the detectors of the different channels can be desirable, for example in order to obtain images with increased resolution. In connection with a camera, the different channels can be used, for example, for applications in the field of autofocus technology, imaging with different light sensitivities, spectral measurements or polarization measurements.

In comparison to reference implementations, the techniques described here enable a multi-path prism which requires comparatively little constructed space. Furthermore, the corresponding multi-path prism can have a comparatively low weight. The complexity of the construction of the corresponding multi-path prism can also be comparatively low. The mechanical requirements for production can thereby be reduced.

In particular, various examples described herein are based on the knowledge that it may be desirable to provide an optical arrangement which is designed as a B4 lens mount in accordance with the BTS S-1005B standard, for example as an intermediate ring. The standard for TV cameras known as the “B4” lens mount is defined in the following document: “BTA 5-1005B” “Interconnection for HDTV Studio Equipment” from the ARIB “Association of Radio Industries and Businesses”/Japan. The optical parameters are described on pages 19 and 20, and the geometrical values are described on page 26. In the definition, a prism block with the following properties is arranged between the lens and the image sensors:

Length of the entire glass path 46.2 mm±0.5 mm;

33.0 mm±4 mm glass A with refractive index 1.52 to 1.75 and Abbe number 42.5 to 50.5; and

13.2 mm±4 mm glass B with refractive index 1.52 and Abbe number 64.2. The length of the entire glass path is 46.2 mm±0.5 mm. The following is also specified: Image field diameter: 11.00 mm; Image field: 9.6 mm×5.4 mm (16: 9); Focal distance in air: 48.00±0.01 from contact surface; Connection diameter: 42.00 m; Focus distance R−G±10 μm; Focus distance B−G±5 μm; Aperture number (F/number): F/1.7 or less—i.e., numerical aperture NA min 0.3.

In this context, various examples described here are based on the further finding that it is not possible or is only possible with difficulty to implement a stack structure having at least three prisms—in particular a stack structure having four prisms, which defines five channels of the optical arrangement—by using the two glasses A and B according to BTA S-1005B. In particular, when using both of the two specified glasses A and B, it may not be possible, or only possible to a limited extent, to comply with the f-number as specified and/or the image field diameter as specified. The f-number defines the ratio of the focal length to the diameter of the effective entrance pupil of a corresponding lens. However, by means of the techniques described herein, it is possible for the optical arrangement to support the f-number of F/1.7 or and/or the image field diameter of 11.0 mm or larger. This means that the primary optical path and the secondary optical paths can each have a correspondingly limited length, and also a homogeneity perpendicular to the respective optical axis, which supports the corresponding image field diameter. This approach enables a distance between the detectors arranged in the focal plane, positioned on one side of the stack structure and the adjacent stack structure, and the principal plane of the lens, positioned on the other side of the stack structure, compliant with the noted f-number. In addition, a corresponding lateral dimension of the light field along the entire glass path, to furnish the image field diameter, can be supported. In general, by means of the techniques described herein, it is possible to obtain images of high quality while complying with the requirements in accordance with the BTA S-1005 standard.

The problem that the f-number and/or the image field diameter and/or, in general, the required imaging quality cannot be implemented, or can only be implemented with difficulty, using the glasses A and B, is addressed in various examples described here by the stack structure being made of exactly one, single glass. In particular, it can therefore be possible to use only one, single glass—rather than two glasses A and B. By way of example, the glass can have a refractive index in the range of from 1.59 to 1.65, optionally in the range of from 1.61 to 1.63. It would be also possible for the glass to have an Abbe number in the range of from 46.8 to 52.8, optionally in the range of from 48.8 to 50.8. This means that the refractive index and/or the Abbe number along the primary path and along the various secondary paths can vary within the respective regions. However, in comparison to a scenario with the glasses A and B, a comparatively small variation of the refractive index and/or Abbe number occurs in the stack structure. A particularly compact design of the stack structure can be achieved in this way. This enables, once again, relatively small f-numbers—in particular, an f-number of F/1.7 or less.

For example, an accordingly compact design of the stack structure can be achieved, enabling a glass path through the stack structure along the primary path, and along the various secondary paths, respectively, in the range of from 43.0 mm to 46.0 mm. This accordingly means that the glass path for light which is assigned to different channels—and which accordingly propagates along different secondary paths—lies within this specified range of from 43.0 mm to 46.0 mm in each case. This particularly allows the same focal lengths for the different channels. It would optionally be possible for the glass path through the stack structure along the primary path and along the various secondary paths to be in the range of from 43.4 mm to 45.4 mm, further optionally in the range of from 44.0 mm to 44.8 mm, and further optionally in the range of from 44.3 mm to 44.6 mm.

It has been noted in this case that, in consideration of such specifications for the glass which is used, different geometric possibilities exist for implementing a corresponding optical arrangement, and in particular a corresponding stack structure having a plurality of prisms which defines a multi-path prism. Exemplary geometric implementations of a corresponding optical arrangement are illustrated below; however, other geometric implementations may be used in further examples as well.

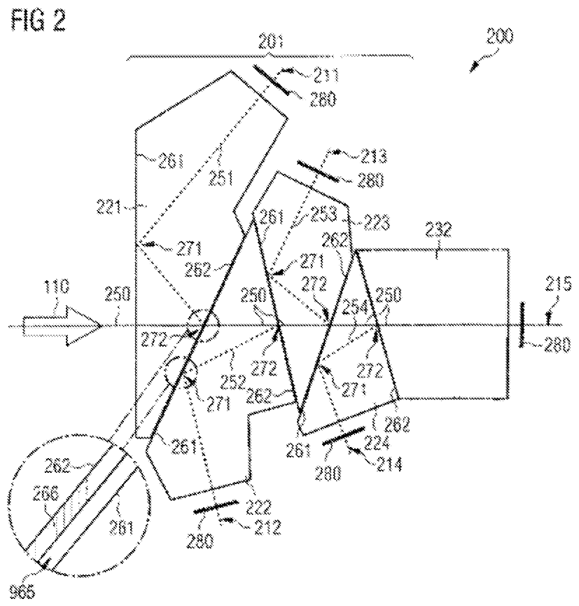

FIG. 2 illustrates an exemplary multi-path prism. Four prisms 221, 222, 223, 224 are sequentially arranged in the corresponding optical arrangement 200. Incident light 110 passes, along a primary optical path 250, first though the outer prism 221 and then through the further prisms 222, 223, 224. The prisms 221, 222, 223, 224 form a stack structure 201. In this case, the prisms 221-224 are stacked in such a manner that the primary optical path 250 alternately crosses first surfaces 261 and second surfaces 262 of the prisms 221-224.

The four prisms 221-224 are all made of the same glass, which has a refractive index in the range of from 1.59 to 1.65 and an Abbe number in the range of from 42.8-52.8.

FIG. 2 at bottom left illustrates an enlargement of the transition between a second surface 262 and a first surface 261—by way of example for the prisms 221, 222. The enlargement is, by way of example, illustrated for two positions along the boundary between the prisms 221, 222. In various examples, the transition has no dependence on the position along the border between the prisms 221, 222. It is thus possible for the surfaces 261, 262 to be identical in shape and design.

The enlargement in FIG. 2 shows that there is an air gap 965 between the surfaces 261, 262. The air gap 965 in the example of FIG. 2 is between the filter 266 and the surface 261. The air gap 965 results in total reflection at the surface 261 due to the sufficiently large angle of incidence of the light partially reflected off surface 262.

Total reflection typically occurs if:

Sine (angle of incidence)*refractive index before surface>refractive index after surface,

wherein the angle of incidence is defined as the angle relative to the perpendicular to the surface.

From FIG. 2 it is apparent that transitions between different optical media—for example, in FIG. 2, air and glass—along the primary optical path 250 within the stack structure 201 only occur through the surfaces of the prisms 221-224 of the stack structure 201. Further optical elements, such as wedges or discs, for example, are not present within the stack structure 201.

The stack structure 201 further comprises one filter 266 for each prism, which filter is arranged parallel to the corresponding second surface 262. For example, the corresponding second surface can integrally form the respective filter 266—that is, can comprise it. The filter 266 selects light with specific optical properties with partial reflection 272 at the second surface 272. In this case, the filter 266 can have different filter characteristics, for example with regard to the filtered spectral range; the filtered polarization; and/or the filtered intensity—that is, transmission.

From FIG. 2 it can further be seen that all of the adjacent surfaces 261, 262 of prisms 221—224 of the stack structure 201 arranged adjacent to each other are parallel to each other. As such, the second surface 262 of the prism 221 is parallel to the first surface 261 of the prism 222; in addition, the second surface 262 of the prism 222 is parallel to the first surface 261 of the prism 223; furthermore, the second surface 262 of the prism 223 is parallel to the first surface 261 of the prism 224. Such a parallel arrangement of adjacent surfaces of prisms 221-224 arranged adjacent to each other can enable a particularly small construction of the stack structure 201, and hence the optical arrangement 200.

With the partial reflection 272 of light at the second surface 262, one secondary optical path 251, 252, 253, 254 per prism 221-224 is connected with the primary optical path 250. In the case of incident light 110, as illustrated in FIG. 2, the partial reflection 272 leads to a splitting of the primary optical path 250. Accordingly, however, it would also be possible, by means of the partial reflection 272, to achieve a combining of light. The various secondary optical paths 251-254 are subject to total reflection 271 at the first surface 261 of the respective prism 221-224. Bauernfeind prisms can be formed in this way. Basically, sufficiently high angles of incidence of the secondary optical paths 251-254 at the first surface 261 lead to the total reflection 271. Therefore, it is desirable to select the geometry of the stack structure 201 and of the various prisms 201 20-224 in such a manner that the angle of incidence of the secondary optical paths 251-254 at the first surface 261 is sufficiently high.

In the example of FIG. 2, the optical arrangement 200 comprises five channels 211, 212, 213, 214, 215. Each channel in the example of FIG. 2 comprises a detector 280 which is arranged in the secondary optical path 251-253 outside of the respective prism, and hence outside of the stack structure 201. As such, one detector 280 is provided per channel 211-215, and is arranged perpendicular to the respective optical path 250-254. In other examples, a light source could also be provided. In this case, one channel 211-214 is formed for each prism 221-224. In a further example, however, more than one channel can be formed per prism 221-224. In the example of FIG. 2, a further channel 215 is formed through the primary optical path 250. To achieve the same glass paths, the different prisms 221-224 all have different shapes; in addition, an optical block 232 is provided adjacent to the prism 224. Also, the block is made of the same glass as the prisms 221-224.

The glass path between the entrance surface 261 and the detectors 280—which are positioned in a focal plane of a lens arranged adjacent to the surface 261—is in the range of from 43.0 mm to 46.0 mm for all channels 111-215. In particular, it is possible that the glass path is equal for all of the channels 211-215. For example, the glass path for the channel 211 is composed of the section along the primary path 250 between the surface 261 and the surface 262 and the secondary path 251. The sections of the glass paths along the primary path 250 are different for the different channels 211-215; to compensate for this, the secondary paths 251-254 each have different lengths.

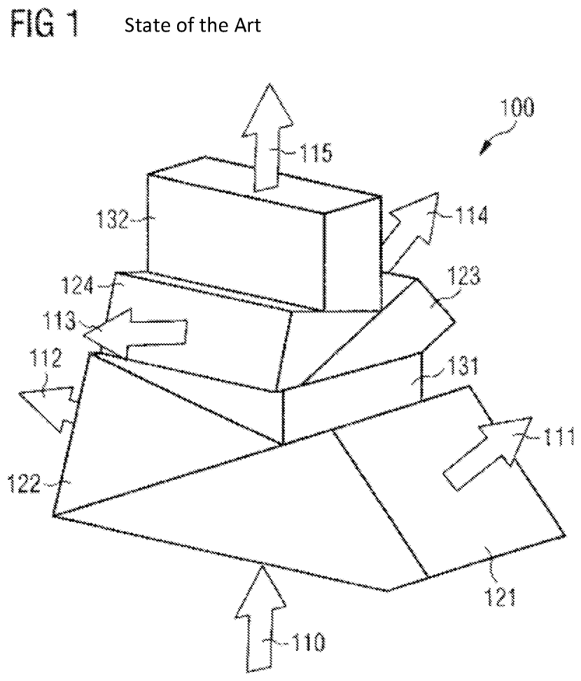

In the example in FIG. 2, the primary optical path 250 and the secondary optical paths 251-254 are all in one plane (in the example in FIG. 2: the plane of the drawing). This enables a small design of the optical arrangement 200-for example, in comparison to the reference implementation according to FIG. 1.

In the example of FIG. 2, the different prisms 221-224 have the same prism angle. The prism angle is defined between the first surface 261 and second surface 262 in each case. However, examples are possible in which the prisms of the stack structure 201 have different prism angles.

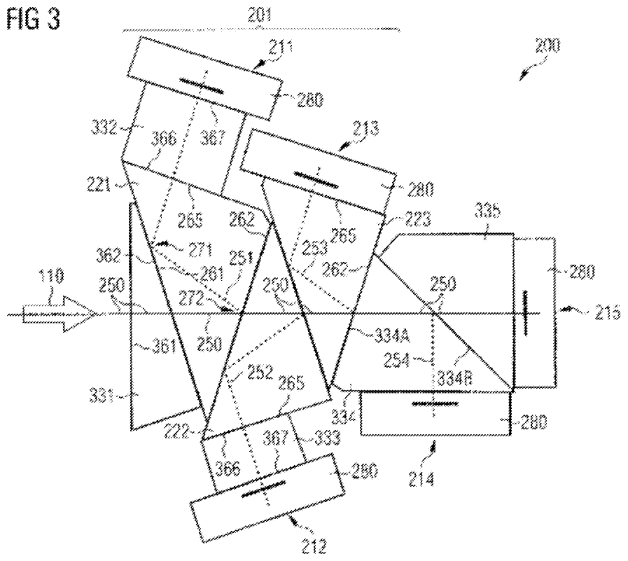

FIG. 3 illustrates a further exemplary multi-path prism 200. In the multi-path prism 200 according to the example of FIG. 3 as well, the prism angle between the first surface 261 and the second surface 262 is the same for all prisms 221-223 of the stack structure 201. FIG. 3 shows that the stack structure 201 only comprises three prisms 221-223, in which the optical sub-paths 251-253 are subject to partial reflection 272 at the respective second surface 262 of the corresponding prism 221-223 and total reflection 271 at the respective first surface 261 of the corresponding prism 221-223.

In the example of FIG. 3, the optical arrangement 200 further comprises a wedge 331 having a first surface 361 and a second surface 362. The first surface 361 and the second surface 362 define a wedge angle of the wedge 331. The wedge 331 is arranged in the primary optical path 250 adjacent to the first surface 261 of the outer prism 221 of the stack structure 201. The second surface 362 of the wedge 331 is parallel to the first surface 261 of the outer prism 221. For example, it is also possible, in relation to the wedge 331, that an air gap exists between the second surface 362 of the wedge 331 and the first surface 261 of the outer prism 221, which results in the total reflection 271 of light along the secondary optical path 251 in the prism 221 (not shown in FIG. 3).

The wedge angle of the wedge 331 in the example of FIG. 3 is 50%, which means that it is half as large as the prism angle of the prisms 221-223 of the stack structure 201. In addition, the wedge 331 facilitates smaller angles of incidence of the primary optical path 250 to the respective second surfaces 262 of prisms 221-223. Moreover, the wedge 331 facilitates larger angles of incidence of the respective secondary optical paths 251-253 onto the first surface 261 of the corresponding prism 221-223. The result is that a lower degree of reflection is achieved in the partial reflection 272, and reliable total reflection 271 is achieved—that is, robustness against tolerances is achieved. As a result, the solid angle from which light can be focused on sensor surfaces of the detectors of the 280 different channels 211-215 is enlarged.

FIG. 3 also shows that all prisms 221-223 of the stack structure are identical in shape. This enables a simple and efficient production of the prism 221-223. In order to achieve the same glass paths, the optical arrangement 200 further comprises optical discs 332, 333 which are arranged adjacent to exit surfaces 265 of prisms 221, 222. The optical discs 332, 333 each comprise a first surface 366 and a second surface 367. The first surface 366 and the second surface 367 are each arranged parallel to each other. Moreover, the first surface 366 and the second surface 367 are arranged parallel to the respective exit surface 265 of the respective prism 221, 222. This prevents the secondary optical path 251, 252 from being deflected or broken.

FIG. 3 illustrates further aspects in relation to a further optical wedge 334 having a first surface 334A and a second surface 3348, which together form a wedge angle. The further optical wedge 334 also acts as a prism, wherein partial reflection 272 only occurs on the second surface 334B. Total reflection of the secondary optical path 254 produced in this manner inside the wedge 334 does not occur. In this respect, the further optical wedge 334 does not form a Bauernfeind prism. The first surface 334A of the further optical wedge 334 is parallel to the second surface 262 of the prism 223; for example, an air gap could again be provided (not shown in FIG. 3). A further optical wedge 335 is arranged behind the further optical wedge 334.

The further optical wedges 334, 335 define two further channels 214, 215. As a result, the multi-path prism according to the example in FIG. 3 comprises three prisms 221-223 and five channels 211-215.

The prisms 221-223, the wedges 331, 334, 335 and the discs 332, 333 could all be made of the same glass.

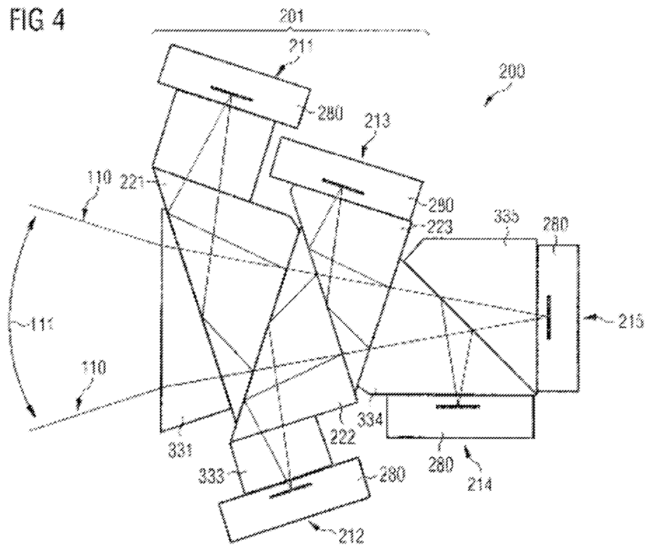

FIG. 4 illustrates aspects in relation to the beam path of light 110 through the optical arrangement 200 of FIG. 3. FIG. 4 shows that light 110 can arrive at the optical arrangement 200, and/or in particular the wedge 331, from a relatively large solid angle 111, and still be focussed on the detectors 280 of the various channels 211-215. This is made possible by low angles of incidence at the first surfaces 261 of the prisms 221-223 and/or the wedge 331.

The solid angle 111 corresponds in this case to an image diameter which is supported by the optical arrangement 200. For example, it is possible to support an image field diameter of 11.0 mm with the optical arrangements 200 illustrated in FIGS. 2-4. In addition, f-numbers of F/1.7 or lower can be supported—specifically because a comparatively small and/or short focal length is enabled by a short glass path.

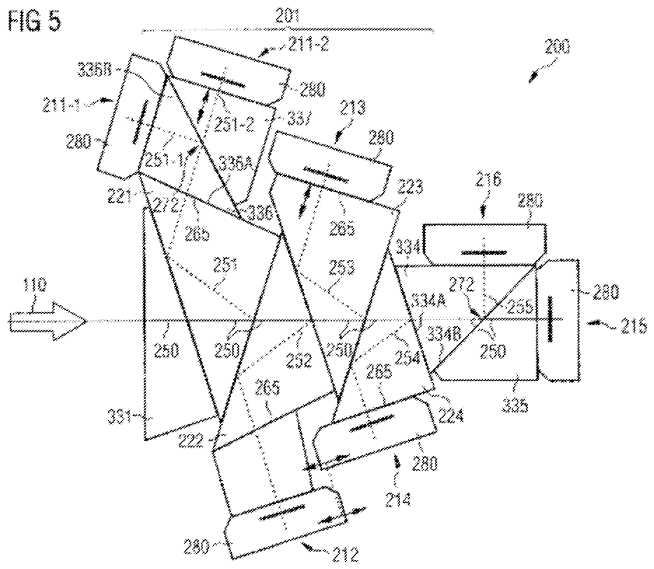

FIG. 5 illustrates a further exemplary multi-path prism. In the corresponding optical arrangement 200 according to the example of FIG. 5—in a manner comparable to that of the example of FIG. 3-the prism angle between the first surface 261 and the second surface 262 is equal for all prisms 221-224 of the stack structure 201. In the example of FIG. 5, the stack structure 201, however, comprises four prisms 221-224. The optical arrangement 200 defines seven channels 211-1, 211-2, 212-216. In this case, a further optical wedge 336 is arranged parallel to the exit surface of the 265 outer prism 221-that is, a first surface 336A of the further optical wedge 336 is arranged parallel to the exit surface 265 of the prism 221. Partial reflection of light of the secondary optical path 251 takes place at a second surface 336B of the further optical wedge 336, thereby generating the secondary optical paths 251-1, 251-2.

In the example of FIGS. 3-5, it can be seen that the immediately adjacent prisms 221-224 have exit surfaces 265 arranged parallel to each other. For example, the exit surface 265 of the prism 221 is parallel to the exit surface 265 of the prism 223 (see FIGS. 3-5). In addition, in the example of FIG. 5, the exit surface 265 of the prism 222 is parallel to the exit surface 265 of the prism 224. Since the exit surface 265 of the various prisms 221-224 are arranged parallel to each other, it is possible that the detectors 280 and/or light sources (not shown in FIGS. 3-5) are also arranged parallel to each other. In particular, for example, the sensor planes of the detectors 280 of immediately adjacent prisms can be arranged parallel to each other. Then, by means of a positioning mechanism, it can be possible to position such detectors 280 arranged parallel to each other in a coupled manner. For example, a positioning parallel to the respective secondary optical path for focusing can be carried out in a coupled manner (indicated in FIG. 5 by the arrows along the secondary optical paths 251-2, 253). Alternatively or additionally, it would also be possible to arrange the detectors 280 correlated perpendicular to the secondary optical paths and/or to position them in a coupled manner (indicated in FIG. 5 by arrows along the detectors 280 of the channels 212, 214). By way of example, in the example of FIG. 5, the sensor planes of the detectors 280 of the channels 212, 214 can be offset with respect to each other by a distance perpendicular to the secondary optical paths 252, 254, which is smaller than the dimension of a pixel of the sensor planes. By combining the sensor data from these detectors 280, an image with higher resolution can then be provided. A sub-pixel overlay is possible.

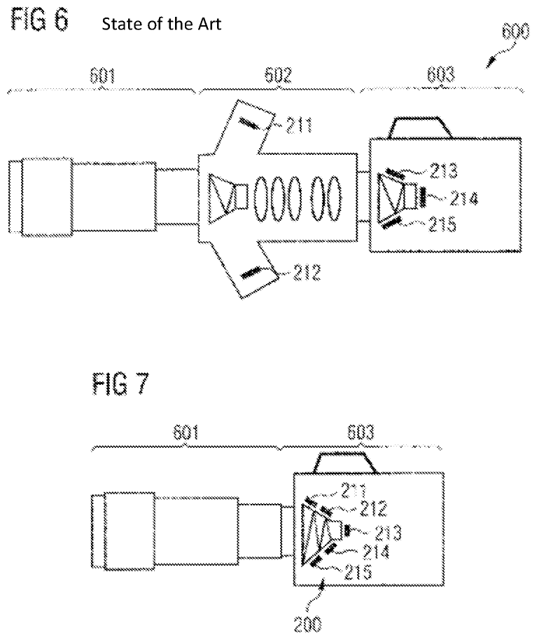

FIG. 6 illustrates aspects in relation to a camera 600 according to the prior art. The camera 600 comprises a lens 601, a first lens connection 602, and a second lens connection 603. The first lens connection 602 is used to provide two channels 211, 212; the channels 211, 212 may be used, for example, for infrared imaging and ultraviolet imaging. The second lens connection 603 comprises a multi-path prism having three channels 213, 214, 215, which can correspond, for example, to the three colour channels red, green and blue.

From FIG. 6 it can be seen that two lens connections 602, 603 are needed to provide all of the channels 211-215. Accordingly, the camera 600 is heavy and unwieldy. In addition, the provision of two lens connections 602, 603 is comparatively expensive and prone to errors.

FIG. 7 illustrates aspects in relation to a camera 600 comprising an optical arrangement 200 in accordance with various exemplary implementations as previously described. The camera 600 comprises the lens 601 and the lens connector 603. The lens connector 603 comprises a multi-path prism according to various examples disclosed herein, having five channels 211-215. The focal lengths of the lens 601 define focal planes in which the detectors 280 of the channels 211-215 are arranged. The f-number of the lens 601 also defines the solid angle 111. Due to the relatively small constructed space required by the multi-path prism 200, it is possible to provide all five of the channels 211-215 in the lens connection 603. This is particularly the case in connection with a so-called B4 lens connection. The B4 lens connection defines the above-mentioned mechanical and optical properties.

In the example of FIG. 7, the multi-path prism 200 is integrated, together with the detector of the channel 213, into the lens connection 603. Due to the compact design of the multi-path prism, it would also be possible for the multi-path prism to be arranged in an intermediate ring without the detector of the channel 213; in this case, the detector of the channel 213 can be arranged in a main body of the camera 600.

In reference implementations, a multi-path prism having three channels (see FIG. 6) is used in a B4 lens connection. The three channels correspond to the spectral ranges red, green and blue. Other wavelength ranges, such as ultraviolet or infrared wavelengths, cannot be taken into account in addition to the channels red, green and blue in such reference implementations due to the limited constructed space of the lens connection. An exemplary application in which the infrared wavelengths are of interest is, for example, the identification of advertising banners for sporting event broadcasts. Based on a coding of the advertising banners in the infrared spectral range, the same can be detected in digital post-processing, and the corresponding pixels can be modified. For example, a user-specific adaptation can be made in this manner. A further exemplary implementation for coding of regions with light in the infrared spectral region concerns the separation of foreground and background. For example, pixels in the area of the background can be digitally replaced. Such techniques are known as, for example, Supponer methods. Such applications can be implemented with a lens connection according to FIG. 7.

In summary, techniques have been described above which relate to the sequential arrangement of at least three prisms in a stack arrangement. A corresponding optical arrangement provides a multi-path prism. In various examples, the stack arrangement comprises five or more prisms.

By means of such techniques, a compact splitting or combination of optical information into five or more channels can be carried out. The techniques described herein make it possible to position detectors and/or light sources of the different channels in a coupled manner. In particular, a coupled positioning along the respective secondary optical paths and/or perpendicular to the corresponding secondary optical paths can take place.

In various embodiments, the optical arrangement also comprises a wedge which is arranged in front of an outer prism of the stack structure. This can enable achieving a particularly simple construction of the stack structure. For example, it can be possible that the prism angles of the various prisms are selected to be equal. Furthermore, the wedge can make it possible for the angle of incidence at the different second surfaces of the prisms to be comparatively small, such that a comparatively high transmittance can be achieved. At the same time, the wedge can make it possible for the angle of incidence at the first surfaces of the prisms to be comparatively small, such that here as well a comparatively high transmittance in the primary path can be achieved, while the total reflection of the light of the secondary paths is reliably achieved at the same time. In addition, the wedge can make it possible for the spacing between adjacent channels to be greater, such that the detectors and/or light sources can be used with larger housings.

The techniques described herein can be used in a wide variety of application fields. In particular, the multi-path prisms as described herein can be used for lens connections which meet the B4 standard. This is the case because the multi-path prisms described here require a comparatively small constructed space and furthermore enable a short glass path.

In summary, the following examples in particular have been described above:

Example 1 An optical arrangement (200), comprising:
stack structure (201) which comprises at least three prisms (221, 222, 223, 224), each with a first surface (261) and an opposite second surface (262),
a primary optical path (250) which runs through the stack structure (201),
for each of the prisms (221, 222, 223, 224) of the stack structure (201): a secondary optical path (251-255) which runs through the corresponding prism (221, 222, 223, 224) and is connected by partial reflection (272) of light at the second surface (262) of the respective prism (221, 222, 223, 224) with the primary optical path (250), and which is subject to total reflection (271) at the first surface (261) of the respective prism (221, 222, 223, 224),
a wedge (331) having a first surface (361) and a second surface (362), wherein the wedge (331) is arranged in the primary optical path (250) adjacent to the first surface (261) of an outer prism (221) of the stack structure (201), and wherein the second surface (362) of the wedge (331) is arranged parallel to the first surface (261) of the outer prism (221),
wherein all adjacent surfaces (261, 262) of prisms (221, 222, 223, 224) of the stack structure (201) arranged next to each other are parallel to each other.

Example 2 The optical arrangement (200) according to Example 1,
wherein the prism angle between the first surface (261) and the second surface (262) is the same for all prisms (221, 222, 223, 224) of the stack structure (201).

Example 3 The optical arrangement (200) according to Example 1 or 2,
wherein all prisms (221, 222, 223, 224) of the stack structure (201) are shaped identically.

Example 4 The optical arrangement (200) according to any one of the preceding examples, which further comprises:
wherein a wedge angle of the wedge (331) is in the range of from 40%-60% of the prism angle of the prisms (221, 222, 223, 224) of the stack structure (201), preferably 50% of the prism angle of the prisms (221, 222, 223, 224) of the stack structure (201).

Example 5 The optical arrangement (200) according to any one of the preceding examples,
wherein the primary optical path (250) and the secondary optical paths all lie in one plane within the stack structure (201).

Example 6 The optical arrangement (200) according to any one of the preceding examples,
wherein each prism (221, 222, 223, 224) of the stack structure (201) further comprises: an exit surface (265) which is arranged perpendicular to the respective secondary optical path (251-255),
wherein the optical arrangement (200) further comprises:
for at least one prism (221, 222, 223, 224) of the stack structure (201): an optical disc (332, 333) arranged in the corresponding optical secondary path (251 -255) adjacent to the exit surface of the corresponding prism (221, 222, 223, 224), having a first surface (366) and a second surface (367) arranged parallel to each other and parallel to the corresponding exit surface (265).

Example 7 The optical arrangement (200) according to any one of the preceding examples,
wherein each prism (221, 222, 223, 224) of the stack structure (201) further comprises: an exit surface (265) which is arranged perpendicular to the respective secondary optical path (251-255),
wherein the optical arrangement (200) further comprises:
for at least one prism (221, 222, 223, 224) of the stack structure (201): a further optical wedge (336), arranged in the corresponding secondary optical path (251-255) adjacent to the exit surface (265) of the corresponding prism (221, 222, 223, 224), having a first surface (336A) and a second surface (336B), wherein the first surface (336A) of the further optical wedge (336) is arranged parallel to the corresponding exit surface.

Example 8 The optical arrangement (200) according to any one of the preceding examples,
wherein each prism (221, 222, 223, 224) of the stack structure (201) further comprises: an exit surface (265) that is arranged perpendicular to the corresponding secondary optical path (251-255),
wherein the exit surfaces (265) of immediately adjacent prisms (221, 222, 223, 224) of the stack structure (201) are parallel to each other.

Example 9 The optical arrangement (200) according to any one of the preceding examples,
wherein transitions between different optical media along the primary optical path (250) within the stack structure (201) are only formed by the surfaces of the prisms (221, 222, 223, 224) of the stack structure (201).

Example 10 The optical arrangement (200) according to any one of the preceding examples, which further comprises, for each prism (221, 222, 223, 224) of the stack structure (201):
a filter (266) which is arranged in parallel to the second surface (262) of the corresponding prism and which carries out the partial reflection of (272) with respect to at least one of the following: the spectral range; polarization; and transmission.

Example 11 The optical arrangement (200) according to any one of the preceding examples,
wherein the prisms (221, 222, 223, 224) of the stack structure (201) are Bauernfeind prisms.

Example 12 The optical arrangement (200) according to any one of the preceding examples, which further comprises, for each prism (221, 222, 223, 224) of the stack structure (201):
at least one channel (211-1, 211-2, 212-216) having at least one of a light source and a detector (280) arranged in the corresponding secondary optical path (251-255) outside of the stack structure (201).

Example 13 The optical arrangement (200) according to Example 12,
wherein the stack structure (201) comprises four prisms (221, 222, 223, 224), and
wherein the optical arrangement (200) comprises at least five channels (211-1, 211-2, 212-216).

Example 14 The optical arrangement (200) according to Example 12 or 13,
wherein the channels (211-1, 211-2, 212-216) comprise detectors (280), each having a sensor plane,
wherein the sensor planes of the detectors (280) of prisms (221, 222, 223, 224) of the stack structure (201) that are immediately adjacent are parallel to each other.

Example 15 The optical arrangement (200) according to Example 14, which further comprises:
a positioning mechanism which is configured to position the sensor planes of the detectors (280) of immediately adjacent prisms (221, 222, 223, 224) of the stack structure (201) in a coupled manner.

Example 16 The optical arrangement (200) according to any one of Examples 12-15,
wherein the channels comprise detectors (280) each having a sensor plane,
wherein the sensor planes of two of the detectors (280) are offset to each other perpendicular to the respective secondary optical paths (251-255) by a distance which is less than the dimension of a pixel of the sensor planes.

Example 17 A lens connection (603) for a camera, comprising:
a stack structure (201) which comprises at least four prisms (221, 222, 223, 224), each having a first surface (261) and an opposite second surface (262),
a primary optical path (250) which runs through the stack structure (201),
for each of the prisms (221, 222, 223, 224) of the stack structure (201): a secondary optical path (251-255) which runs through the corresponding prisms and which is connected by partial reflection (272) of light at the second surface (262) of the respective prism (221, 222, 223, 224) with the primary optical path (250), and is subject to total reflection (271) at the first surface (261) of the respective prism (221, 222, 223, 224),
wherein all adjacent surfaces of prisms (221, 222, 223, 224) of the stack structure (201) arranged next to each other are parallel to each other.

Example 18 The lens connection (603) according to Example 17,
wherein the lens connection (603) comprises the optical arrangement (200) according to any one of Examples 1-16.

Of course, the features of the previously described examples of the invention can be combined with each other. In particular, the features can be combined not only in the described combinations, but also in other combinations, or can be used individually without departing from the field of the invention.

For example, various implementations were described above in relation to the splitting of optical information and/or optical paths. Corresponding techniques can also be directly applied for an implementation in reference to the combining of optical information and/or of optical paths.

For example, various uses were described in reference to a lens connection. However, it is also possible to use optical arrangements which implement a multi-path prism, as herein described, in other applications. A further exemplary field of application is, for example, a multi-colour light source for fluorescence microscopy. In this case, for example, ten or more channels-for example, more than twelve channels-can be provided with corresponding LEDs as light sources. The LEDs can, for example, be combined with collecting lenses. By combining the respective secondary optical paths, an output along a single primary optical path can be implemented.

Furthermore, various techniques were described above in which a wedge is used in connection with a stack structure of a plurality of prisms. However, the use of such a wedge is optional.

1. An optical arrangement, comprising:
a stack structure made of at least one glass, comprising at least three prisms, each having a first surface and an opposite second surface,
a primary optical path which runs through the stack structure, and
for each of the prisms of the stack structure: a secondary optical path which runs through the corresponding prism and is connected with the primary optical path by partial reflection of light at the second surface of the respective prism,
wherein the glass path through the stack structure along the primary path and along each of the various secondary paths is in the range of from 43.0 mm to 46.0 mm.

2. The optical arrangement according to claim 1,
wherein the refractive index of the at least one glass along the primary path and along each of the various secondary paths is in the range of from 1.59 to 1.65.

3. The optical arrangement according to claim 1,
wherein the Abbe number of the at least one glass along the primary path and along each of the various secondary paths is in the range of from 46.8 to 52.8.

4. The optical arrangement according to claim 1,
wherein the stack structure is made of exactly one glass.

5. The optical arrangement according to claim 1,
wherein the glass path through the stack structure along the primary path and along each of the various secondary paths is in the range of from 43.4 mm to 45.4 mm, optionally in the range of from 44.0 mm to 44.8 mm.

6. The optical arrangement according to claim 1,
wherein the optical arrangement supports an f-number of F/1.7 or less of a lens arranged adjacent thereto, and/or wherein the optical arrangement supports an image field diameter of 11.0 mm or greater.

7. The optical arrangement according to claim 1,
wherein the stack structure comprises four prisms, and wherein the optical arrangement comprises at least five channels, and wherein optionally the channels comprise detectors, each having one sensor plane,
wherein the sensor planes of the detectors of prisms of the stack structure that are immediately adjacent are parallel to each other.

8. A lens connection for a camera, comprising:
the optical arrangement according to claim 1.

9. The lens connection according to claim 8,
wherein the lens connection is designed as a B4 connection according to the Broadcasting Technology Association standard S-1005B.

10. The lens connection according to claim 8,
wherein the lens connection is designed as an intermediate ring.

11. The optical arrangement according to claim 1,
wherein the refractive index of the at least one glass along the primary path and along each of the various secondary paths is in the range of from 1.61 to 1.63.

12. The optical arrangement according to claim 1,
wherein the Abbe number of the at least one glass along the primary path and along each of the various secondary paths is in the range of from 48.8 to 50.8.

13. The optical arrangement according to claim 1,
wherein the glass path through the stack structure along the primary path and along each of the various secondary paths is in the range of from 44.0 mm to 44.8 mm.

14. The optical arrangement according to claim 1,
wherein the glass path through the stack structure along the primary path and along each of the various secondary paths is in the range of from 44.3 mm to 44.6 mm.

15. The optical arrangement according to claim 1,
wherein the optical arrangement supports an f-number of F/1.7 or less of a lens arranged adjacent thereto.

16. The optical arrangement according to claim 1,
wherein the optical arrangement supports an image field diameter of 11.0 mm or greater.

17. The optical arrangement according to claim 1,
wherein the optical arrangement supports an f-number of F/1.7 or less of a lens arranged adjacent thereto and wherein the optical arrangement supports an image field diameter of 11.0 mm or greater.
